(19) United States
(12) Patent Application Publication
(10) Pub. No.: US 2014/0304129 A1
(43) Pub. Date: Oct. 9, 2014

(54) Surrender and management of software licenses

(71) Applicants: Juan-Carlos Colosso, Mt. View, CA (US); Katherine K. Nadell, Sunnyvale, CA (US); Xuejun Xu, Cupertino, CA (US)

(72) Inventors: Juan-Carlos Colosso, Mt. View, CA (US); Katherine K. Nadell, Sunnyvale, CA (US); Xuejun Xu, Cupertino, CA (US)

(21) Appl. No.: 11/585,512

(22) Filed: Oct. 23, 2006

(51) Int. Cl. G06Q 50/18; G06Q 40/00

(52) U.S. Cl. CPC G06Q 50/184; G06Q 40/00
USPC 705/35; 705/310

(57) ABSTRACT

A vendor-operated server can be configured to receive requests from one or more customers to return corresponding sets of (one or more) software licenses for financial credit. In response to receiving a request to return a set of software licenses, the vendor-operated server verifies the return of the set of software licenses to ensure that the customer (making the request) no longer uses the software licenses to operate the vendor's software application(s). After receiving and confirming a return of the set of software licenses back to the vendor-operated server, the vendor-operated server provides notification to, for example, a vendor's corresponding order management system (e.g., financial/license management system) to indicate that the customer has returned the set of software licenses. This verification ensures that the customer does not inadvertently or intentionally continue to use the vendor's software application after obtaining credit for the returned licenses.

### RELATED APPLICATIONS

This application is related to United States patent applications entitled “LICENSE DISTRIBUTION,” (Attorney Docket No. ADO06-014(B327), “OVERDRAFT LICENSES AND LICENSE DISTRIBUTION,” (Attorney Docket No. ADO06-016(B329), “SOFTWARE LICENSE DISTRIBUTION AND REGISTRATION BYPASSING,” (Attorney Docket No. ADO06-021 (B365), all of which are being filed on the same date as the present application (by the common assignee Adobe Systems, Inc.), the entire teachings of all of which are incorporated herein by this reference.

### BACKGROUND

Software vendors typically require a user to purchase a license to use their corresponding software applications. For example, in a retail setting, a respective user can purchase a CD-ROM (Compact Disk Read Only Memory) or other type of storage media that is encoded with a software program for installation onto a respective computer system owned by the user. Such a CD-ROM can include an associated serial number packaged with the CD-ROM. The serial number provided by the vendor enables a user to perform an installation procedure of the software and allows operation of the software application stored on the CD-ROM within the computer system on which the software is installed.

As an alternative to obtaining the software from a retail vendor, a user may download software over a network such as the Internet from a remote server. The user can then execute an installation program that comes with the downloaded software that then installs the software onto the computer. During purchase over the network, a user may be provided with a serial number or other authorization code that must be entered when installing the software to allow proper operation of the software on the computer. The serial number thus acts as a key to unlock the use of the software. If a user enters an incorrect serial number, the software may not install properly or may not operate once installed.

As an example, when downloading or attempting to execute the software program, a respective installer program for installing the software application on the user's computer system may require the user to input the correct serial number associated with the CD-ROM or provided to the user (i.e. from a server) when downloading the program. Upon receipt of the serial number by the installer program, the installer program may send the serial number over a network such as the Internet to a server managed by the vendor of the software program being downloaded. In general, the vendor's server uses the serial number to track and identify which specific copy of the software application is being downloaded and installed for operation onto a respective user's computer system.

In addition to the serial number, the vendor's server may require further input (e.g., a user's, name, address, business, email address, etc.) from a respective user to register and/or install the software program for use. After obtaining such information from the user, the server typically provides an authentication code enabling the respective user to install and/or execute the software program on the user's computer system. Certain software vendors enable mass distribution of software licenses for large volume customer accounts. Typically, mass distribution includes distribution of, for example, twenty or more software licenses over a publicly accessible server managed by the vendor. After distribution of a set of purchased software licenses to a customer, such vendors may allow a respective volume customer (e.g., a customer who purchases many licenses) to obtain credit on one or more of the licenses without actual return of the software licenses. For example, to obtain credit for one or more software licenses according to conventional methods, the customer sends a signed letter (i.e., a hand-delivered letter) to the vendor indicating a number of software licenses that the customer would like to obtain credit. Typically, the customer includes a promise in the signed letter. The promise typically indicates that the customer destroyed or will destroy a set of activation codes associated with the software licenses being returned to assure the vendor that the activation codes will no longer be used to operate the vendor's software after receiving the credit.

### SUMMARY

Conventional techniques for obtaining credit associated with a set of software licenses suffer from a number of deficiencies. For example, conventional techniques enable a respective customer to obtain credit for one or more purchased software licenses via a signed letter stating that the customer has destroyed or promises to destroy software licenses (e.g., activation certificates or authorization codes) used to operate the vendors software as discussed above. However, according to such conventional techniques, the vendor relies on the signed letter and provides a credit to the customer without proof that the customer actually destroyed the software licenses. The customer may inadvertently forget to destroy the activation codes and continue to operate the vendor's software. Accordingly, the customer may continue using the software without paying for its use. This is not fair to the vendor that extended the credit to the customer.

Techniques discussed herein deviate with respect to conventional applications such as those discussed above as well as other techniques known in the prior art. For example, certain specific embodiments herein are directed to overcoming deficiencies associated with the above-mentioned techniques and/or other deficiencies in the prior art not mentioned above.

For example, in a general embodiment as described herein, a vendor-operated server can be configured to receive requests from one or more customers to return corresponding sets of (one or more) software licenses for financial credit. According to one configuration, the vendor previously distributed the software licenses (e.g., activation certificates) to enable operation of the vendor's software application. In response to receiving a request to return a set of software licenses, the vendor-operated server tracks the return of the set of software licenses to ensure that the customer (making the request) no longer uses the software licenses to operate the vendor's software application(s). After receiving and confirming a return of the set of software licenses at the vendor-operated server, the vendor-operated server provides notification to, for example, a vendor's corresponding order management system (e.g., financial/license management system) to indicate that the customer has returned the set of software licenses. Accordingly, the vendor-operated server according to embodiments herein enables a respective customer to specify a number of software licenses to be returned for credit and thereafter provides a notification upon verifying the return of the software licenses. This verification provides assurance to the vendor that the customer does not inadvertently or intentionally continue to use the vendor's software application after obtaining credit for the returned licenses.

Embodiments herein contrast with conventional return policies that rely on a customer's promise to destroy a set of distributed software licenses as discussed above. For example, as discussed above, conventional techniques do not prevent inadvertent or intentional continued use of a purportedly destroyed set of software licenses (that should have been destroyed by the customer). This can be detrimental to a software development company that spends an enormous amount of money developing a product and relies on corresponding usage fees to support funding of software development. Embodiments herein support verification that a respective customer actually discontinues use of and/or actually returns a set of one or more software licenses.

Methods and/or systems enabling retraction of software licenses as described herein can vary depending on the application. For example, according to one embodiment herein, a vendor-managed server supports a web portal for transmitting information to and receiving input from respective customers over a publicly accessible network. The web portal of the vendor-managed server can support distribution of software licenses amongst client computers associated with customer purchasing software licenses. Additionally, the web portal of the vendor-managed server can support retraction of software licenses from the client computers for credit as discussed above. As an example, upon receiving a request by a customer to return one or more software licenses through the web portal, the vendor-managed server can track collection of software licenses directly returned from the clients to the vendor-managed server. In addition to such embodiments, a respective customer-operated server (e.g., a server in a local area network managed by the customer) at a remote location with respect to the vendor-managed server can collect one or more software licenses from its corresponding clients. In an alternative embodiment, instead of receiving the returned licenses directly from the customer's clients, the customer-managed server can be configured to collect returned software licenses from clients. In such an embodiment, the vendor-managed server can be configured to communicate with the customer-managed server to retrieve or collect the group of software licenses being returned for credit.

One example of a software license is an activation certificate that enables use of the vendor's software. In this example embodiment, the vendor-managed server can communicate (or receive communications) over a publicly accessible network to retrieve or receive activation certificates previously used by respective client computers to operate the vendor software. Upon return of a corresponding activation certificate (e.g., software license) by a respective client computer, functionality associated with the vendor software application at the client computer initiates deletion of the returned activation certificate from its storage (e.g., trusted storage) so that the respective client computer can no longer operate the vendor software application. In other words, the vendor software used to facilitate a transfer of activation certificates from one network resource (e.g., the client) to another (e.g., the server) ensures that a respective copy of the activation certificate is deleted after it is transmitted from one network resource to another. Thus, in certain embodiments, because software licenses are destroyed as they forwarded, there are no duplicate copies of the activation certificates (e.g., software license) in the licensing system as they are forwarded through the network. This prevents a respective user from returning a copy of the activation certificate for credit while also retaining a copy of the activation certificate for continued use of the vendor's software.

Note that embodiments herein can include a configuration of one or more computerized devices, workstations, handheld or laptop computers, or the like to carry out and/or support any or all of the method operations disclosed herein. In other words, one or more computerized devices or processors can be programmed and/or configured to operate as explained herein to carry out different embodiments of the invention.

Yet other embodiments herein include software programs to perform the steps and operations summarized above and disclosed in detail below. One such embodiment comprises a computer program product that has a computer-readable medium including computer program logic encoded thereon that, when performed in a computerized device having a processor and corresponding memory, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein.

Accordingly, one particular embodiment of the present disclosure is directed to a computer program product that includes a computer readable medium having instructions stored thereon for supporting operations such as enabling verification that one or more software licenses have been surrendered. The instructions, when carried out by a processor of a respective computer device, cause the processor to: i) receive a request for electronic return of a set of software licenses for financial credit, the set of software licenses originally allocated for use by a customer to operate a corresponding vendor software application; ii) in response to receiving the request, track and/or verify the electronic return of the set of software licenses; and iii) provide notification that the customer has returned the set of software licenses. The numbering of the steps has been added for clarity sake, these steps need not be performed in any particular order.

Other embodiments of the present disclosure include software programs to perform any of the method embodiment steps and operations summarized above and disclosed in detail below.

Also, it is to be understood that the system, method and apparatus herein can be embodied strictly as a software program, as a hybrid of software and hardware, or as hardware alone such as within a processor, or within an operating system or a within a software application. Example embodiments of the invention may be implemented within products and/or software applications such as those manufactured by Adobe Systems, Inc. of San Jose, Calif., USA.

As discussed above, techniques herein are well suited for use in distribution and retraction of software licenses. However, it should be noted that embodiments herein are not limited to use in such applications and that the techniques discussed herein are well suited for other applications as well. Note that each of the different features, techniques, configurations, etc. discussed herein can be executed independently or in combination. Accordingly, the present invention can be embodied and viewed in many different ways.

Note that this summary section herein does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives (permutations) of the invention, the reader is directed to the Detailed Description section and corresponding figures of the present disclosure as further discussed below.

### BRIEF DESCRIPTION OF THE DRAWINGS

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles and concepts.

FIG. 1 is an example diagram of a computer network environment enabling retraction or return of licenses for credit according to embodiments herein.

FIG. 2 is an example diagram illustrating information associated with a set of returned software licenses and crediting of a respective customer's account according to embodiments herein.

FIG. 3 is an example diagram of a computer network environment enabling retraction of software licenses according to embodiments herein.

FIG. 4 is an example of a computer environment and corresponding computer system enabling a respective customer to obtain credit for returned licenses according to embodiments herein.

FIG. 5 is a flowchart illustrating an example of a method for verifying a return of software licenses according to embodiments herein.

FIGS. 6 and 7 combine to form an example flowchart illustrating more specific techniques of enabling verifying the return of a set software licenses according to embodiments herein.

### DETAILED DESCRIPTION

According to an example embodiment as described herein, a vendor distributes software licenses (e.g., activation certificates) to a customer, enabling operation of the vendor's software application by one or more clients associated with the customer. A server such as a vendor-operated server receives a request from a customer to return a set of (one or more) software licenses for financial credit. In response to receiving the request to return a set of software licenses, the vendor-operated server tracks the return of the set of software licenses to verify and confirm that the customer (making the request) actually returns the software licenses and therefore no longer uses the software licenses to operate the vendor's software application(s). After receiving and confirming a return of the set of software licenses back to the vendor-operated server, the vendor-operated server provides notification to, for example, a vendor's corresponding order management system (e.g., financial/license management system) to indicate that the customer has returned the set of software licenses. The order management system can be configured to credit the customer's account depending on whether the customer actually returns the software licenses.

Accordingly, a vendor-operated server according to embodiments herein enables a respective customer to specify a number of software licenses to be returned for credit and thereafter provide notification upon verifying the return of the software licenses. This verification ensures that a respective customer actually surrenders a set of activation certificates used to operate the vendor's software application so that the customer cannot inadvertently or intentionally continue to use the vendor's software application after obtaining credit for the returned licenses.

As discussed above, embodiments herein contrast with conventional return policies that rely on the customer's promise to destroy a set of distributed software licenses. For example, as discussed above, inadvertent or intentional continued use of a purportedly destroyed set of software licenses can be detrimental to a software development company that spends an enormous amount of money developing a product and relies on corresponding usage fees to support finding of software development. In other words, a customer should not be afforded free use of a vendor's software application after obtaining credit for a set of software licenses that a customer promises to return. Embodiments herein provide novel ways of preventing unauthorized continued use of a set of one or more software licenses.

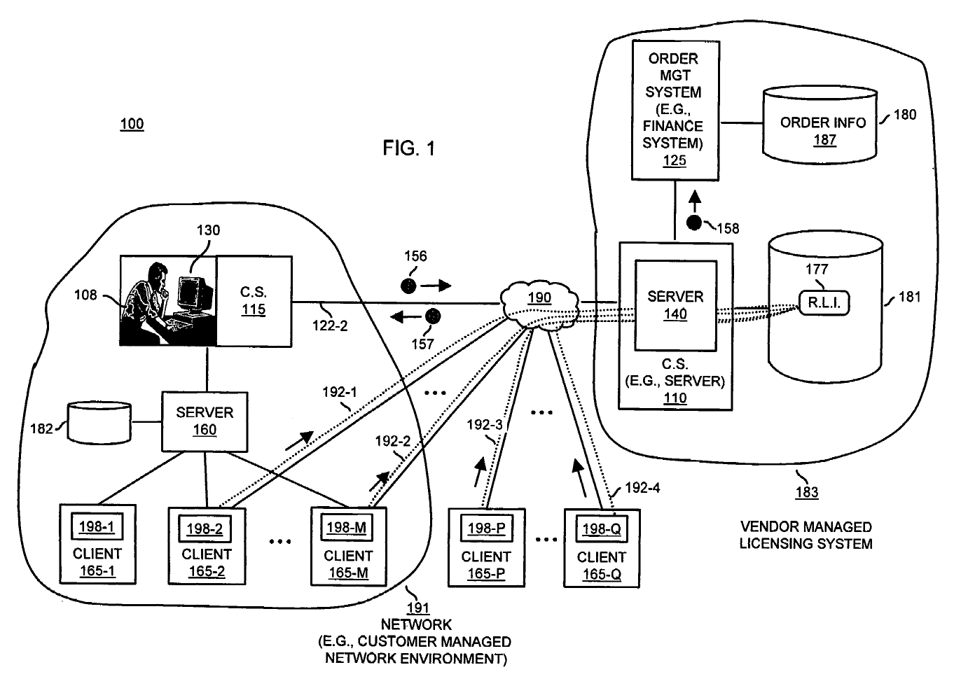

FIG. 1 is a diagram of a computer network environment 100 for verifying a return of one or more software licenses according to embodiments herein. As shown, computer network environment 100 includes network 191 (e.g., a customer-managed network), network 190 (e.g., a publicly accessible network such as the Internet), and a vendor managed licensing system 183 (e.g., a system managed by a corresponding software vendor). The vendor management licensing system 183 includes an order management system 125, repository 180 for storing order information 187, computer system 110 for supporting server 140, and repository 181 for storing returned license information 177 (e.g., information associated with a set of returned software licenses).

Network 191 such as a customer-managed network environment includes user 108, display screen 130, computer system 115, server 160, repository 182, and clients 165 (e.g., client 165-1, client 165-2, client 165-3, . . . , client 165-M). Computer network environment 100 also includes client 165-P, . . . client 165-Q associated with the customer that operates network 191. These latter clients (namely, clients 165-P . . . 165-Q) can be home-based computers in which a customer's employees work out of their homes and have access to a public network such as the Internet. Each of clients 165 can include a corresponding software license 198 (e.g., authorization code, activation certificate, user rights, etc.) to operate a corresponding vendor software application.

In one embodiment, each of clients 165 (e.g., end users such as employees, terminal computer equipment such as a personal computer, etc.) includes a computer device operated by a respective user in an organization (e.g., customer). The organization can be a company, firm, group of persons, etc. that obtain and utilize software licenses 198 distributed by a respective vendor that distributes software licenses electronically via server 160 and/or server 140.

As mentioned above, in order to execute one or more vendor software applications on a respective client 165, the corresponding client first obtains a software license 198 via a respective distribution channel such as from server 160 and/or server 140. For example, according to one configuration, the clients 165 obtain licenses 198 from server 160. According to another configuration, the clients 165 obtain software licenses 198 from (vendor-managed) server 140 over network 190.

Also as mentioned above, the software licenses 198 enable the clients 165 to operate one or more vendor software applications installed on the clients 165. The software licenses 198 can be activation certificates produced according to an algorithm managed by the vendor. As an example, during a software license distribution phase, the vendor can produce a respective activation certificate (e.g., software license) for a client by first obtaining a “fingerprint” associated with the client that will use the license. The fingerprint can include information such as personal information associated with a user, information associated with a customer or organization to which the user belongs, unique information associated with a respective computer terminal, etc.

After retrieval of fingerprint information, the vendor applies an algorithm to the fingerprint information to produce an activation certificate (e.g., a unique set of digital information based on information associated with a client using the software license) that is provided to the client 165 for enabling use of the vendor software. In addition to activation certificates, the software licenses 198 according to embodiments herein can be any other type of resource that enables use of corresponding vendor software.

The following disclosure illustrates example embodiments in which a user 108 (e.g., a network administrator or employee associated with an organization that purchases a set of software licenses 198) can initiate return of one or more of software licenses 198 for credit (e.g., financial credit).

More specifically, as illustrated in FIG. 1, user 108 can access a web portal supported by computer system 110 via communications 156. This access can include accessing a respective information portal of computer system 110 via use of a respective URL (Uniform Resource Locator). In response to communications 156, the vendor-managed server 140 can initiate display of a respective graphical user interface on display screen 130 for viewing by the user 108 based on communications 157. Note that use of a web portal is used by way of example and that any appropriate type of communication over link 122-1 can be used to retrieve information or provide information and/or commands to vendor-managed server 140.

During communications with vendor-managed server 140 (and a respective web portal or information portal associated with computer system 110), the user 108 can provide an indication (e.g., via input to a graphical user interface on display screen 130) to the server 140 of how many software licenses the user 108 (e.g., customer) would like to return for credit. For example, if the customer has chosen to host multiple pools of licenses at different locations (e.g., licensing server sources) such as some at a privately managed server as well as a vendor-managed server, the customer can be given a choice at this time of which pool the licenses should be returned from.

More specifically, assume that a user has sixty licenses distributed from an in-house server and forty licenses distributed from a vendor-managed server. If the user wants credit back for ten of the one hundred total licenses, the user 108 may want to choose whether to “deduct” or return the licenses from the in-house server (e.g., customer managed server) or the vendor-managed server. According to one configuration, this choice can be made up front when the user 108 specifies how many licenses credit is sought. Alternatively, the choice of returning licenses can be made later such as when the desired number of licenses have been given back or amassed at a respective server. Upon occurrence of such an event, the customer (e.g., user 108) can be automatically notified when the appropriate number of licenses has been amassed at the respective server so that the user 108 can go visit a respective portal (of the server holding the returned licenses) to “release” the licenses back to the vendor. At that point, the user can confirm from which pool (e.g., location) to delete the licenses.

Vendor-managed server 140 can be configured to notify order management system 125 of the user's request to return one or more software licenses for credit. In such an embodiment, the order management system 125 in turn applies a respective credit to the customer based on a promise that the respective customer will either destroy or eventually return the software licenses 198 back to the vendor-managed server 140 (or other designated resource associated with the vendor). Future orders for software licenses can be denied until the order management system 125 receives notification from the vendor-managed server 140 that the customer actually returned the software licenses to the vendor as promised. Note that in alternative embodiments, the order management system 125 may not provide a credit to the customer for the respective software licenses until the designated software licenses 198 are actually returned to the vendor as described herein.

In either case, vendor-managed server 140 can be configured to at least temporarily store a set of returned software licenses (e.g., one or more previously used unique activation certificates that were generated based on personal information of the client using the activation certificate) in repository 181 as corresponding returned license information 177. After verifying a return of a set of software licenses (as specified by the user 108), the vendor-managed server 140 provides a notification to order management system 125. Accordingly, the order management system 125 can be notified whether a respective customer (e.g., user 108) follows through with a promise to return a set of software licenses. If required to apply credit to a respective customer's account, the “return” notification or verification of returned licenses from server 140 can serve as a basis for crediting the customer's account with monetary funds or other types of credit that are redeemable by the customer.

The clients 165 can return respective licenses to the vendor-managed server 140 in a number of different ways. For example, according to one configuration, the user at a respective client 165 can manually (e.g., voluntarily) initiate return of a respective software license 198 back to the server 140 over network 190. In such an embodiment, the user can utilize a help menu to identify and execute a command to forward the respective software license back to a designated source.

The client 165 also can initiate a function (based on a user initiated “uninstall” command) associated with the installed vendor software (e.g., a so-called uninstaller) to initiate return of the software license 198 over network 190 to vendor-managed server 140. Execution of the function (e.g., via an application programming interface call) causes removal and forwarding of the software licenses from the respective client 165 over network 190 to vendor-managed server 140. Thus, the user at a respective client 165 can initiate execution of vendor software to return a software license provided by the vendor.

Independent of input provided by a respective user at a client machine, the clients 165 also can be prompted to return respective software licenses based on a command or notification from a respective remote resource such as from server 160, user 108, and/or vendor-managed server 140. In other words, user 108 such as a network administrator can initiate return of a respective activation certificate at a client 165 back to server 140 via an operating system management command applied to the client 165. When initiated, such a command provided by the user 108 causes execution of an “uninstall” function (to remove the activation certificate and not necessarily the software application) as discussed above such that the respective one or more clients 165 receiving this type of command from the user remove and forward their corresponding software license 198 over network 190 to server 190 or other designated source. Accordingly, many types of external resources can initiate return of a set of software licenses back to vendor-managed server 140 (or other specified source).

As previously discussed, the server 140 can provide the user with a graphical user interface enabling the user to request a return of a set of one or more software licenses. The graphical user interface served or presented to the user 108 by server 140 can indicate which clients 16 associated with the customer have corresponding software licenses to operate the vendor's software. Accordingly, based on information provided by the server 140, the respective user 108 can thereafter send appropriate commands (e.g., operating system commands) to the one or more clients 165 that will be required to return their respective software licenses 198.

One example of a software license 198 is an activation certificate (e.g., a unique certificate including a cryptography-based key) that enables use of the vendor's software. The vendor software can employ cryptography techniques (with respect to the activation certificate) to enable use of vendor software. The activation certificate can enable operation of the vendor software only from a respective client 165 for which the activation certificate is registered for use.

Upon return of a corresponding activation certificate (e.g., software license 198) by a respective client 165, functionality associated with the vendor software application at the client 165 initiates deletion of the returned software license (e.g., activation certificate) from its storage (e.g., trusted storage) so that the respective client 165 can no longer operate the vendor software application. In other words, the vendor software (at the client computer) used to facilitate a transfer of the software license from the client 165 in network 191 to server 140 ensures that a respective copy of the software license 198 is deleted after it is transmitted from the client 165 to a destination such as server 140. Thus, in certain embodiments, there are no duplicate copies of the software license (e.g., activation certificate) in computer network environment 100. This prevents a respective client from returning a copy of the software license for credit while retaining a copy of the software license for continued use of the vendor's software.

In the context of the present example as shown in FIG. 1, assume that the user 108 communicates with vendor-managed server 140 to indicate to the server 140 how many software licenses will be returned for credit. Assume in this example that the customer (e.g., Acme Development Company) requests to return a set of twelve software licenses that are used to operate Acrobat™ version 8.0. Assume that the twelve software licenses were originally part of an order for one hundred software licenses 198. In this case, the customer is requesting a partial return of a license order. However, note that the server 140 can be configured to deny partial returns and require that the customer return all purchased or be denied any credit. Also, the server 140 (or server 160 as the case may be) can be configured to reject a request for returning software licenses if the request does not occur within a specified time limit such as within a time of first distributing the software licenses to the customer for use.

As shown for this partial return example, a group of clients 165 returning the software licenses communicate over respective communication paths 192 to surrender their respective software licenses. For example, client 165-2 forwards software license 198-2 over communication path 192-1 to vendor-managed server 140; client 165-M forwards software license 198-M over communication path 192-2 to vendor-managed server 140; client 165-P forwards software license 198-P over communication path 192-3 to vendor-managed server 140; client 165-Q forwards software license 198-Q over communication path 192-4 to vendor-managed server 140, and so on.

Note that communication paths 192 are shown by way of example only and that clients can forward (or user 108 can extract) the respective software licenses along different paths from a respective client 165 back to the vendor-managed server 140 (or other destination) for storage as returned license information 177 in repository 181. For example, the clients 165 can alternatively forward the software licenses 198 along paths such as from clients 165 through server 160 and over network 190 to vendor-managed server 140. As yet another alternative, the clients 165 can forward respective software licenses 198 to computer system 115 that in turn forwards the software licenses over network 190 to vendor-managed server 140.

Upon receipt of the twelve returned software licenses 198 (or portion thereof) to returned license pool 177 as illustrated, the vendor-managed server 140 can notify order management system 125 that the customer returned a specified amount of software licenses 198.

Order management system 125 of vendor managed licensing system 183 can include people and/or corresponding computer resources for managing software license information for many different customers in addition to the license information maintained for user 108. Order management system 125 stores order information 187 associated with previously distributed software licenses 198. Order information 187 stored in repository 180 can include customer information associated with different customers such as the name or identifier of a customer placing previous purchase orders, purchase order numbers, a payment status of the order, billing information, authorization information enabling operation of target software, a number of licenses and corresponding versions/features of the software licenses being purchased, etc.

Based on the order information 187 in repository 187, the order management system 125 can determine whether or not a set of one or more licenses 198 requested to be returned by the customer are eligible for financial or other type of credit. If a set of software licenses is not eligible for credit, the order management system 125 can immediately provide such notification to the vendor-managed server 140 that, in turn, notifies the user 108 via communication over link 122-2. If the software licenses can be returned for credit, the order management system 125 can provide such notification to vendor-managed server 140. The vendor-managed server 140 can in turn begin tracking a return of the software licenses from the clients 198 as previously discussed.

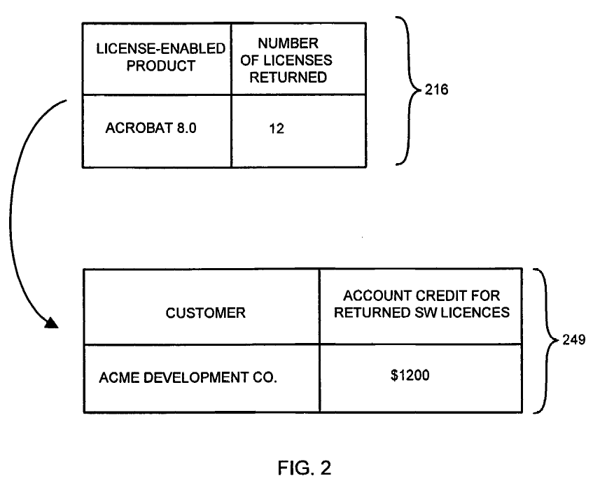

FIG. 2 is an example diagram illustrating status information 216 associated with a set of returned software licenses 198 as managed by vendor-managed server 140 according to embodiments herein. Status information 216 reflects a status of returned software licenses (e.g., software license 198-2, software license 198-M, software license 198-P, software license 198-Q, etc.) stored in returned license information 177.

Assume in this example that the server 140 detects a return of twelve licenses as specified by status information 216. As shown, the status information 216 produced by vendor-managed server 140 indicates appropriate information such as a type as well as a number of software licenses 198 being returned by a respective customer for credit. In the context of the present example, status information 216 (as tracked by vendor-managed server 140) indicates a return of twelve Acrobat™ 8.0 licenses as requested by the user 108 as discussed above.

According to one configuration, the vendor-managed server 140 forwards this status information 216 (or similar information) to order management system 125. In this way, the vendor-managed server 140 provides notification to the order management system 125 that the twelve software licenses have been returned by the customer. In response to receiving the notification, the order management system 125 applies a credit to the customer's account. For instance, in the present example, the order management system 125 applies one hundred dollars of credit for each software license returned by the customer. Accordingly, the customer's account 249 is credited with one thousand two hundred dollars.

Referring again to FIG. 1, the vendor-managed server 140 can initiate deletion of the returned software licenses. For example, after applying credit to the customer's account 249, the order management system 125 can notify the vendor-managed server to initiate deletion of the software license information stored in returned license pool 177. As an alternative, the vendor-managed server 140 can delete the software license information in returned license pool 177 before, during, or after a time of notifying order management system 125 that the appropriate number of software licenses have been returned by the customer. In other words, since the licenses have been returned, the activation certificates or other authorization codes will not be needed to operate the vendor's software.

In addition to crediting a respective customer's account, the server 140 or other vendor manages resource can provide notification to user 108 of the returned software licenses and corresponding available credit.

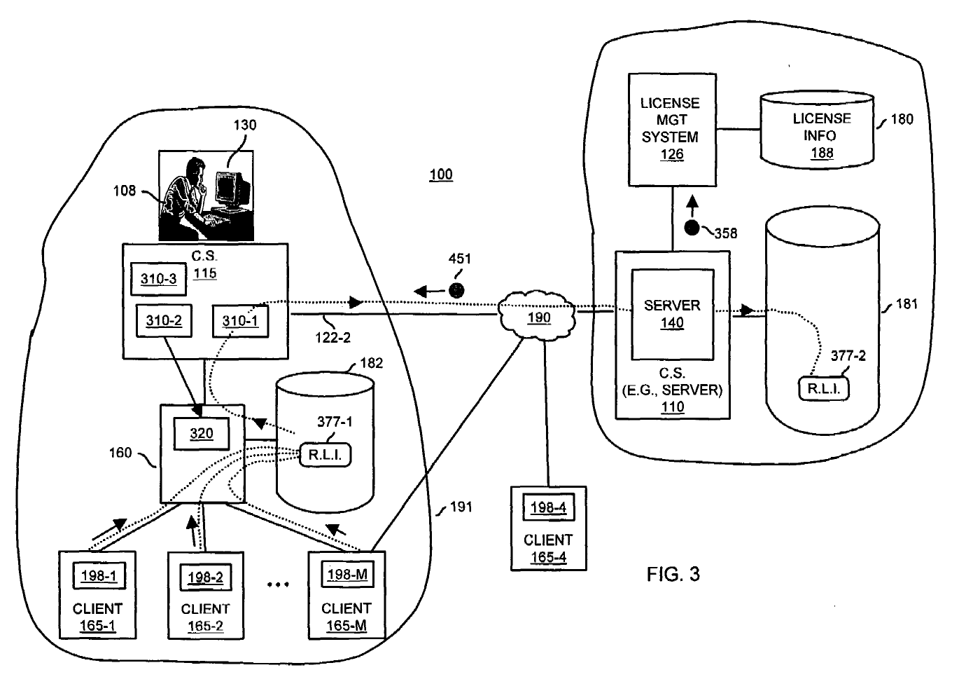

FIG. 3 is an example diagram illustrating use of multiple utilities 310 provided by a vendor to support collection and return of software licenses via use of a customer managed server (e.g., server 160) according to embodiments herein.

In the example embodiment shown, via communication 451, the vendor-managed server 140 provides utility 310-1 (e.g., a charge or discharge utility tool), utility 310-2 (e.g., server programming software), and utility 310-3 (e.g., administration software) over network 190 and link 122-2 to user 108 at computer system 115. Note that the user 108 at computer system 115 executes the utilities 310 to carry out different functions as further discussed below.

For example, utility 310-2 enables the user 108 to program server 160 with appropriate vendor software (e.g., license distribution manager 320) enabling distribution and collection of the software licenses 198.

Utility 310-3 enables the respective user 108 to manage the distribution and collection of software licenses at server 160. In other words, the user 108 can use utility 310-3 to configure server 160 to receive (or retrieve) software licenses 198 from clients 198 for storage in repository 182 as returned license information 377-1.

Lastly, utility 310-1 enables user 108 to initiate a transfer of returned software licenses 198 from returned license pool 377-1 over network 190 to vendor-managed server 140 that stores the software licenses in repository 181 as returned license information 377-2.

Software application 320 can track the return of the software licenses 198 in repository 182 in a similar way that server 140 tracks returned software licenses 198. However, in this example, the server 160 collects and tracks the electronic return of software licenses 198 as previously discussed. Via utility 310-1, user 108 initiates a transfer of the returned software licenses in repository 182 to vendor-managed server 140. In response to receiving a number of returned software licenses from server 160 as specified by the user 108 as previously discussed, the vendor-managed server 140 provides a respective notification to order management system 125.

Note that in addition to specifying a return of software licenses based on a collection of software licenses at either server 140 (e.g., a remote server managed by the vendor) or server 160 (e.g., a local server managed by the customer), the user can split a request so that server 140 performs a collection of one or more software licenses and server 160 performs a collection of one or more software licenses. Thus, the user 108 can designate which network source or sources to return the software licenses.

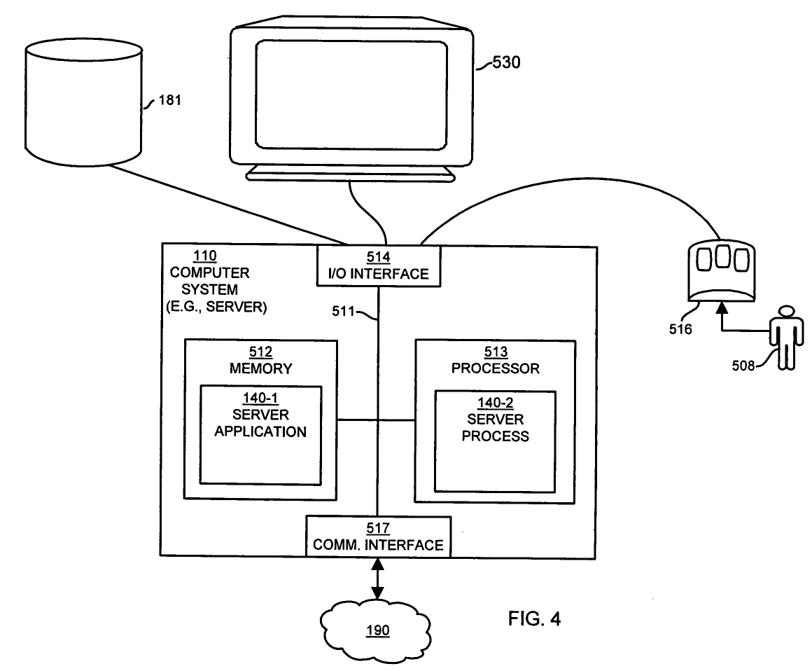

FIG. 4 is a block diagram of a computer environment illustrating an example architecture of a respective computer system 110 (e.g., a server) for implementing server 140 (e.g., server application 140-1 and/or server process 140-2) according to embodiments herein. As previously discussed, server 160 can be configured in a similar way as server 140 to support collection and forwarding of software licenses according to embodiments herein. Computer system 110 can be a computerized device such as a personal computer, workstation, portable computing device, console, network terminal, processing device, network device, etc.

As shown, computer system 110 of the present example includes an interconnect 511 that couples a memory system 512, a processor 513, I/O interface 514, and a communications interface 515. I/O interface 514 provides connectivity to peripheral devices 516 (if such devices are present) such as a keyboard, mouse (e.g., selection tool 116), display screens (e.g., display medium 530), etc. User 508 (e.g., a server administrator) can provide input to computer system 110 if and when necessary. Communications interface 515 enables computer system 110 to communicate over network 190 to retrieve and transmit information as previously discussed.

As shown, memory system 512 is encoded with server application 140-1 that supports software license distribution and collection as discussed above and as discussed further below. Server application 140-1 can be embodied as software code such as data and/or logic instructions (e.g., code stored in the memory or on another computer readable medium such as a disk) that supports processing functionality according to different embodiments described herein. During operation of one embodiment, processor 513 accesses memory system 512 via the use of interconnect 511 in order to launch, run, execute, interpret or otherwise perform the logic instructions of the server application 140-1. Execution of the server application 140-1 produces processing functionality in server process 140-2. In other words, the server process 140-2 represents one or more portions of the server application 140-1 performing within or upon the processor 513 in the computer system 110.

It should be noted that, in addition to the server process 140-2 that carries out method operations as discussed herein, other embodiments herein include the server application 140-1 itself (i.e., the un-executed or non-performing logic instructions and/or data). The server application 140-1 may be stored on a computer readable medium (e.g., a repository) such as a floppy disk, hard disk or in an optical medium. According to other embodiments, the server application 140-1 can also be stored in a memory type system such as in firmware, read only memory (ROM), or, as in this example, as executable code within the memory system 512 (e.g., within Random Access Memory or RAM).

In addition to these embodiments, it should also be noted that other embodiments herein include the execution of the server application 140-1 in processor 513 as the server process 140-2. Thus, those skilled in the art will understand that the computer system 110 can include other processes and/or software and hardware components, such as an operating system that controls allocation and use of hardware resources.

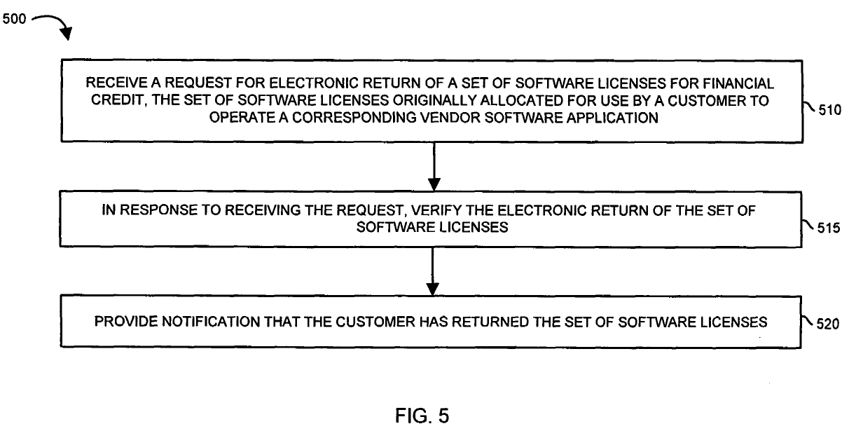

Functionality supported by computer system 110 and, more particularly, functionality associated with server application 140-1 and server process 140-2 will now be discussed via flowcharts in FIGS. 5 through 7. For purposes of the following discussion, the server 140 (e.g., server application 140-1 and/or server process 140-2) of computer system 110 generally performs steps in the flowcharts. Server 160 can perform similar functions when so assigned to distribute software licenses as discussed above.

Note that there will be some overlap with respect to concepts discussed above for FIGS. 1 through 4. Also, note that the steps in the below flowcharts need not always be executed in the order shown.

FIG. 5 is a flowchart 500 illustrating a technique of verifying a return of software licenses according to embodiments herein. Note that flowchart 500 of FIG. 5 and corresponding text below will make reference to matter previously discussed with respect to FIGS. 1-4.

In step 510, the server 140 receives a request for an electronic return of a set of software licenses 198 for financial credit. The software licenses 198 to be returned are originally allocated for use (to a respective customer and its clients 165) to operate a corresponding vendor software application. In one embodiment, as previously discussed, the electronic return includes return of unique activation certificates over a publicly accessible network to server 140.

In step 515, in response to receiving the request, the server 140 verifies the electronic return of the set of software licenses 198. In other words, the server 140 tracks a return of multiple software licenses.

In step 520, the server 140 provides notification (to the order management system 125) that the customer has returned the set of software licenses 198.

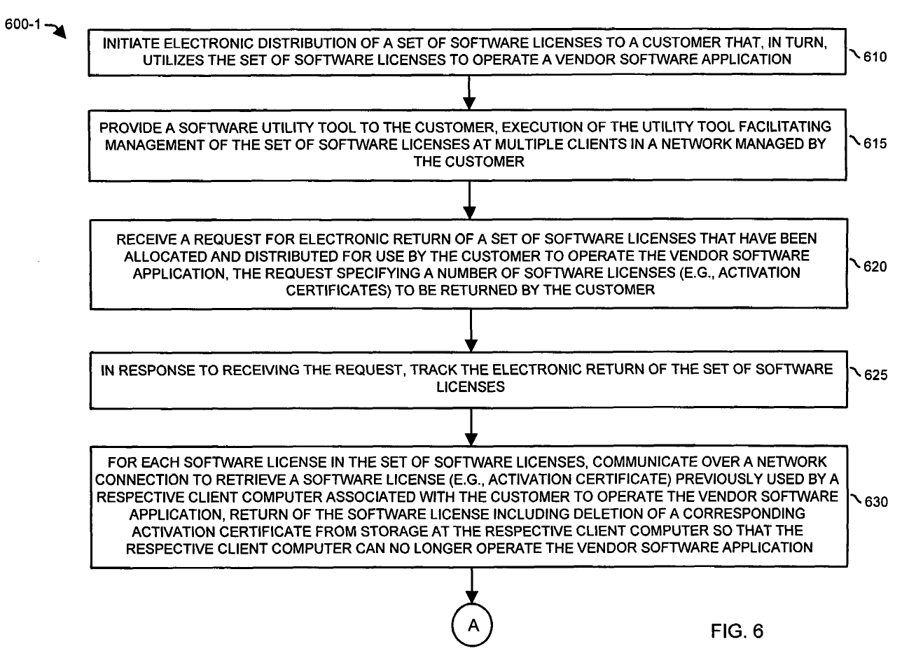

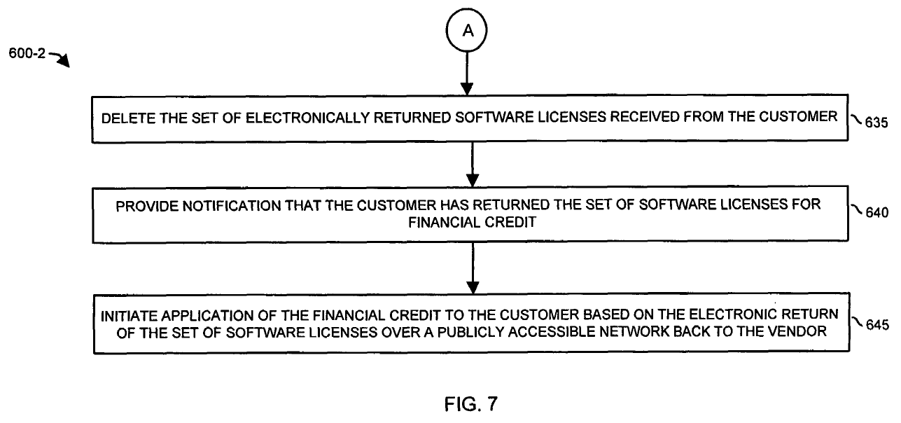

FIGS. 6 and 7 combine to form a flowchart 600 illustrating more specific techniques associated with embodiments herein. Note that according to the present example embodiment, the steps in flowcharts 600-1 and 600-2 (collectively, flowchart 600) are carried out by a processing entity such as server 140. However, the entity (e.g., computer system, combination of computer systems, server, etc.) that executes the operational steps below can vary depending on the configuration. For example, server 160 or other collection node can be programmed to perform similar operations.

In step 610, the server 140 initiates the electronic distribution of a set of software licenses to a customer (e.g., clients 165) that, in turn, utilizes the set of software licenses to operate the vendor's software application.

In step 615, the server 140 provides software utility tools (e.g., utility 310) to the customer. Execution of the utility 310-3 (as discussed above with respect to FIG. 3) facilitates management of the set of software licenses at multiple clients 165 in a network 191 managed by the customer.

In step 620, the server 140 receives a request for electronic return (e.g., retrieval of an activation certificate over a network) of a set of software licenses that have been allocated and distributed for use by the customer to operate a vendor software application. The request specifies a number of software licenses 198 (e.g., activation certificates) to be returned by the customer

In step 625, the server 140 tracks the electronic return of the set of software licenses 198 in response to receiving the request.

In step 630, for each software license in the set of software licenses, the server 140 communicates over a network connection to retrieve a software license (e.g., activation certificate) previously used by a respective client computer associated with the customer to operate the vendor software application. Return of a software license includes deletion of a corresponding activation certificate from storage at the respective client computer so that the respective client computer can no longer operate the vendor software application.

In step 635, the server 140 deletes the set of electronically returned software licenses received from the customer.

In step 640, the server 140 provides notification (to order management system 125) that the customer has returned the set of software licenses for financial credit.

In step 645, the server 140 initiates application of the financial credit to the customer based on the electronic return of the set of software licenses over a publicly accessible network (e.g., network 190) back to the vendor (e.g., server 140).

Note again that techniques herein are well suited for retraction of software licenses. However, it should be noted that embodiments herein are not limited to use in such applications and that the techniques discussed herein are well suited for other applications as well.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A method comprising:
receiving, by a vendor computing device, a request for electronic return of a set of software licenses for financial credit, each license of the set of software licenses comprising an activation certificate, the activation certificate comprising information that authorizes operating a corresponding vendor software application at a client computer device;
in response to receiving the request, verifying the electronic return of the set of software licenses; and
providing notification, by the vendor computing device, that the set of software licenses has been returned.

2. A method as in claim 1 further comprising:
initiating application of the financial credit based on confirmation of the electronic return of the set of software licenses over a publicly accessible network, the electronic return including collection of the activation certificates.

3. A method as in claim 1 further comprising:
initiating application of the financial credit prior to receiving confirmation of the electronic return of the set of software licenses over a publicly accessible network.

4. A method as in claim 1 further comprising:
prior to receiving the request, initiating electronic distribution of the set of software licenses; and
wherein verifying the electronic return of the set of software licenses includes communicating with a license distribution server, the license distribution server distributing the set of software licenses, to retrieve the set of software licenses from the license distribution server.

5. A method as in claim 1, wherein verifying the electronic return of the set of software licenses includes:
for each returned software license in the set of software licenses, receiving the activation certificate previously used by a respective client computer device to operate the vendor software application, return of the activation certificate including deletion of the activation certificate from storage at the respective client computer device so that the respective client computer device can no longer operate the vendor software application.

6. A method as in claim 5, wherein receiving the activation certificate occurs in response to receiving input from the respective client computer device, the input initiating return of the activation certificate over a publicly accessible network to a server managed by the vendor computing device that tracks the return of the set of software licenses.

7. A method as in claim 5, wherein receiving the activation certificate occurs in response to the vendor software application in the respective client computer device initiating return of the activation certificate over a publicly accessible network.

8. A method as in claim 1 further comprising:
providing a software utility tool, execution of the utility tool facilitating management of the set of software licenses at multiple client computer devices in a network; and
wherein verifying the electronic return of the set of software licenses includes communicating over a network connection with the software utility tool to collect the software licenses.

9. A method as in claim 1, wherein receiving the request includes receiving a value specifying a number of software licenses and corresponding activation certificates that are to be returned, the activation certificates being previously distributed to respective client computer devices to operate the vendor software application, the method further comprising:
in response to detecting a return of the specified number of activation certificates over a publicly accessible network, initiating application of the financial credit.

10. A method as in claim 1 further comprising:
initiating application of the financial credit based on confirming destruction of the set of software licenses over a publicly accessible network back to the vendor computing device.

11. A method as in claim 1 further comprising:
initiating deletion of the returned software licenses.

12. A method as in claim 1, wherein receiving the request includes:
via a respective web portal, enabling receipt of communications from a representative of the customer over a publicly accessible network; and
receiving a command from the representative over the publicly accessible network to return the software licenses for the financial credit.

13. (canceled)

14. A computer program product comprising a non- transitory computer-readable medium embodying instructions for processing data information, such that the instructions, when carried out by a processing device, enable the processing device to perform the operations of:
receiving a request for electronic return of a software license for financial credit, the software license comprising an activation certificate, the activation certificate comprising information that authorizes operating a vendor software application at a client computer device, the vendor software application configured to use the software license during operation at the client computer device, the vendor software application further configured to provide the request for electronic return of the license;
in response to receiving the request, verifying the electronic return of the software license; and
providing notification that the software license has been returned.

15. A computer program product as in claim 14 further supporting operations of:
initiating application of the financial credit based on confirmation of the electronic return of the software license over a publicly accessible network.

16. A computer program product as in claim 14 further supporting operations of:
initiating application of the financial credit prior to receiving confirmation of the electronic return of the software license over a publicly accessible network.

17. A computer program product as in claim 14 wherein verifying the electronic return of the software license includes communicating with a license distribution server, the license distribution server used to distribute the software license, to retrieve the software license from the license distribution server.

18. A computer program product as in claim 14, wherein verifying the electronic return of the software license comprises verifying deletion of the activation certificate from storage at the client computer device so that the respective client computer device can no longer operate the vendor software application.

19-20. (canceled)

21. A computer program product as in claim 14 further supporting operations of:
providing a software utility tool, execution of the utility tool facilitating management of the set of software licenses at multiple client computer devices in a network; and
wherein verifying the electronic return of the set of software licenses includes communicating over a network connection with the software utility tool to collect the software licenses.

22. (canceled)

23. A computer program product as in claim 14 further supporting operations of:
initiating application of the financial credit based on confirming destruction of the software license over a publicly accessible network.

24. A computer program product as in claim 14 further supporting operations of:
initiating deletion of the returned software license.

25-29. (canceled)

30. The method of claim 1, wherein the client computer device comprises a desktop or laptop computer.

31. A computer program product comprising a non-transitory computer-readable medium embodying instructions that when carried out by a processing device enable the processing device to perform the operations of:
operating a vendor software application based on a license for the vendor software application, the license comprising an activation certificate comprising information that authorizes operating the vendor software application, wherein functionality of the vendor software application is unavailable if the license is not present; and in response to a command provided to the vendor software application, returning the license.

32. (canceled)

33. The computer program product of claim 31, wherein returning the license comprises deleting the activation certificate.

34. The computer program product of claim 33, wherein after deleting the activation certificate, the client computer device can no longer operate the vendor software application.

35. The method of claim 1 wherein the information is uniquely associated with the client computer device on which the activation certificate is located such that it authorizes operating the corresponding vendor software application only at the client computer device.

36. The method of claim 35 wherein each activation certificate was produced by applying an algorithm to unique information associated with a respective client computer device.

37. The method of claim 1 wherein each activation certificate was produced by applying an algorithm to unique information associated with personal information.

38. The method of claim 1 wherein each activation certificate comprises a unique set of digital information based on information associated with the client device that is using the license, the activation certificate having been provided to the client device for enabling use of the vendor software application at the client device.
